(19) United States
(12) Patent Application Publication
(10) Pub. No.: US 2013/0238321 A1
(43) Pub. Date: Sep. 12, 2013

(54) DIALOG TEXT ANALYSIS DEVICE, METHOD AND PROGRAM

(71) Applicants: Akihiro Tamura, Tokyo (JP); Kai Ishikawa, Tokyo (JP)

(72) Inventors: Akihiro Tamura, Tokyo (JP); Kai Ishikawa, Tokyo (JP)

(73) Assignee: NEC CORPORATION, Minato-ku, Tokyo (JP)

(21) Appl. No.: 13/884,044

(22) PCT Filed: Nov. 22, 2011
(86) PCT No.: PCT/JP2011/006490

§ 371 Date: May 8, 2013

(30) Foreign Application Priority Data
Nov. 22, 2010 (JP) 2010-259673

(51) Int. Cl. G06F 17/27

(52) U.S. Cl. CPC G06F 17/2785
USPC 704/9

(57) ABSTRACT

A dialog text analysis device generates data for text processing from a dialog text. A negative judging means 81 decides whether or not an event of a first utterance in a dialog text which is a text including content of a plurality of utterances is negated by a second utterance which exists subsequent to the first utterance. When the event of the first utterance is negated by the second utterance, the data for text processing generation means 82 generates data for text processing which is data in which the negated event of the first utterance is eliminated from the dialog text.

### TECHNICAL FIELD

The present invention relates to a dialog text analysis device, a dialog text analysis method and a dialog text analysis program which analyze a dialog text which represents content of utterances and generate data for text processing which is used to perform text processing such as analysis such as mining or search.

### BACKGROUND ART

To accurately perform processing such as an objective text for analysis or search, it is desirable to analyze the text by distinguishing between an affirmative fact and a negative fact. The affirmative fact is a fact consisted of an affirmative event. In other words, the affirmative fact is a fact which indicates affirmative content with respect to an event. Further, a negative fact is a fact consisted of a negative event. In other words, a negative fact can also be referred to as a fact which indicates negative content with respect to an event. For example, as to an event that “connection to a network is established”, an affirmative fact is a fact that “connection to a network is established” and a negative fact is a fact that “connection to a network is not established”.

For example, a case will be described where a text which represents a “connection to a network is established” situation (affirmative fact) is searched on texts accumulated at a call center. In this case, if a text simply including words such as “network” and “connection” is searched without taking into account whether or not an event described in a text is affirmative or negative, a “connection to a network is not established” case (negative fact) is also included in a search result. As a result, search precision decreases.

Hence, in search processing, a described event is desirably distinguished as an affirmative fact or a negative fact and handled. Further, not only upon search processing but also upon most of text analysis such as text mining or summarization, distinguishing between an affirmative fact and a negative fact is important to perform precise analysis.

Non Patent Literature 1 discloses text mining which can absorb variations of negative expressions. According to text mining disclosed in Non Patent Literature 1, morphological analysis of a text is performed to search for a case corresponding to a user's question (query), and, when an adjective “no”, an auxiliary verb “does not” or an adjective verb “impossible” is included in a segment, a negative flag is assigned to this segment. Further, upon search, matching is also performed for a negative flag by using data to which a negative flag is assigned, so that a case which is suitable to a query is precisely searched.

Non Patent Literature 2 discloses a method of deciding factuality as to whether a predicate of an event indicates an affirmative fact or a negative fact. With the method disclosed in Non Patent Literature 2, first, a model which estimates factuality of a predicate (event) is created in advance according to a learning algorithm factorial CRF (Conditional random fields) using the learning Corpus in which factuality is allocated to each predicate which represents an event. As features of a model, a predicate which represents an event, information about morphemes in segments before and after a segment which includes this predicate, information about morphemes in segments of a modification destination and a modification source, and a sense classification included in a functional expression dictionary created in advance are used. Further, by extracting a feature from an objective predicate (event) for analysis and inputting the feature in the model which is created in advance and is used to estimate factuality, the factuality of the objective predicate (event) for analysis is decided.

In addition, Non Patent Literature 3 discloses an adjacency pair used in convention analysis. The adjacency pair refers to an utterance pair which achieves a basic interaction such as a question and a reply or invitation and acceptance. When two utterances are X and Y, the adjacency pair is determined according to rules that (1) X and Y are at adjacent positions, (2) X and Y are produced by different speakers, (3) a first portion X precedes a second portion Y and (4) X requests Y of a fixed format.

Further, Non Patent Literature 4 discloses an identification method of identifying an adjacency pair. In case of the method disclosed in Non Patent Literature 4, a dialog act of each utterance is given from a dialog act of a preceding N utterance, prosodic information of an objective utterance for analysis, time information and reference information, and utterances which form an adjacency pair are identified.

### CITATION LIST

### Non Patent Literature

NPL 1: “Text Mining Solution”, [online], Littel Co., Ltd., [searched on Nov. 2, 2010], Internet <URL:http://littel.co.jp/textmine/textmine004.html>
NPL 2: Hiraku MORITA, Chitose SAO, Suguru MATSUYOSHI, Yuji MATSUMOTO, and Kentaro INUI “Analyzing the Factuality of Textual Information”, 7th Forum on Information Technology, (FIT2008), Vol. 2, pp. 259 to 260, 2008.
NPL 3: Masato ISHIZAKI and Yasuharu DEN “Computation and Language, Volume 3: Discourse and Dialog”, The University of Tokyo Press, pp. 140 to 150, 2001.
NPL 4: Yosuke MATSUSAKA, Mika ENOMOTO, and Yasuharu DEN, “Simultaneous Prediction of Dialog Acts and Address Types in Three-party Conversations”, Proc. 9^{th} International Conference on Multimodal Interfaces (ICMI 07), pp. 66 to 73, 2007.

### SUMMARY OF INVENTION

### Technical Problem

In a text which represents content of speeches (referred to as a “dialog text” below) among various types of texts, factuality of an event indicated by an utterance (that is, whether an event indicates an affirmative fact or a negative fact) is determined by a plurality of speeches of a plurality of people. FIG. 18 is an explanatory view illustrating an example of a dialog text. A dialog text illustrated in FIG. 18 is an example of communication data obtained at a call center. The dialog text illustrated in FIG. 18 includes speakers and a speech text which represents content spoken by the speakers. This content is identified by a number indicated by a speech index. Hereinafter, an utterance identified by a speech index “N” is simply referred to as a “speech of the speech index “N”. Meanwhile, N is a positive integer.

Factuality of an event that “Jamming occurs at a discharge slot” of a speech index “9” illustrated in FIG. 18 is a hypothetical state at a point of time when the utterance of the speech index “9” is made. Then, when content of the utterance of the speech index “9” is negated in the utterance of the speech index “10”, it is found out for the first time that the utterance of the speech index “9” is a negative fact.

Further, in a dialog text, factuality of an event which is determined once is changed later by of confirmation or asking. For example, an event that “It is a printer of company A” of a speech index “14” illustrated in FIG. 18 is once determined as an affirmative fact. However, the event that “It is a printer of company A” is changed to a negative fact based on an utterance of confirmation in the utterance of the speech index “15” and an utterance of a speech index “16” which is a reply.

In particular, in a dialog made at a call center between an operator and a client, the operator frequently confirms an important matter by way of parroting. Hence, a response to this confirmation changes the once-determined factuality in many cases. As described above, in a dialog text, factuality of an event is determined or changed in relation to subsequent utterances.

However, with the text mining disclosed in Non Patent Literature 1 and the method disclosed in Non Patent Literature 2, the factuality of this event is determined using information of one sentence which describes the event as a clue. That is, data (referred to as “data for text processing” below) used in text processing such as analysis like mining or search is set of factuality determined per sentence. Hence, the data for text processing in this case also includes facts which are different from actual facts such as a hypothetical fact which is determined by subsequent utterances and a fact the factuality of which is changed by subsequent utterances.

For example, the hypothetical affirmative fact that “Jamming occurs at a discharge slot” of the speech index “9” illustrated in FIG. 18 and the fact that “It is a printer of company A” of the speech index “14” which is subsequently negated are also included in data for text processing as affirmative facts obtained by text analysis. As a result, it is not possible to perform accurate text processing. For example, there are problems that search precision decreases, mining precision decreases and summarization precision decreases.

It is therefore an object of the present invention to provide a dialog text analysis device, a dialog text analysis method and a dialog text analysis program which can generate data for text processing for which text processing such as analysis like mining or search can be precisely performed, from a dialog text in which factuality of an event is determined or changed in relation to subsequent utterances.

### Solution to Problem

The dialog text analysis device according to the present invention comprises: negative judging means which judges whether or not an event of a first utterance in a dialog text which is a text including content of a plurality of utterances is negated by a second utterance which exists subsequent to the first utterance; and data for text processing generation means which, when the event of the first utterance is negated by the second utterance, generates data for text processing which is data in which the negated event of the first utterance is eliminated from the dialog text.

The dialog text analysis method according to the present invention includes: deciding whether or not an event of a first utterance in a dialog text which is a text including content of a plurality of utterances is negated by a second utterance which exists subsequent to the first utterance; and when the event of the first utterance is negated by the second utterance, generating data for text processing which is data in which the negated event of the first utterance is eliminated from the dialog text.

The dialog text analysis program according to the present invention causes a computer to execute: negative judging processing of judging whether or not an event of a first utterance in a dialog text which is a text including content of a plurality of utterances is negated by a second utterance which exists subsequent to the first utterance; and data for text processing generation processing of, when the event of the first utterance is negated by the second utterance, generating data for text processing which is data in which the negated event of the first utterance is eliminated from the dialog text.

### Advantageous Effects of Invention

The present invention can generate data for text processing for which text processing such as analysis like mining or search is precisely performed, from a dialog text.

### BRIEF DESCRIPTION OF DRAWINGS

FIG. 1 It depicts a block diagram illustrating an example of a dialog text analysis device according to a first exemplary embodiment of the present invention.

FIG. 2 It depicts a flowchart illustrating an example of an operation of the dialog text analysis device according to the first exemplary embodiment.

FIG. 3 It depicts a block diagram illustrating an example of a dialog text analysis device according to a second exemplary embodiment of the present invention.

FIG. 4 It depicts a flowchart illustrating an example of an operation of the dialog text analysis device according to the second exemplary embodiment.

FIG. 5 It depicts a block diagram illustrating an example of a dialog text analysis device according to a third exemplary embodiment of the present invention.

FIG. 6 It depicts a flowchart illustrating an example of an operation of the dialog text analysis device according to the third exemplary embodiment.

FIG. 7 It depicts a block diagram illustrating an example of a dialog text analysis device according to a fourth exemplary embodiment of the present invention.

FIG. 8 It depicts a flowchart illustrating an example of an operation of the dialog text analysis device according to the fourth exemplary embodiment.

FIG. 9 It depicts an explanatory view illustrating an example of an adjacency pair.

FIG. 10 It depicts a block diagram illustrating an example of negative judging means.

FIG. 11 It depicts an explanatory view illustrating an example of information stored in a negative utterance database.

FIG. 12 It depicts a block diagram illustrating another example of negative judging means.

FIG. 13 It depicts an explanatory view illustrating an example of data for text processing.

FIG. 14 It depicts an explanatory view illustrating an example of data for text processing.

FIG. 15 It depicts an explanatory view illustrating an example of data for text processing.

FIG. 16 It depicts an explanatory view illustrating an example of data for text processing.

FIG. 17 It depicts a block diagram illustrating an example of a minimum configuration of a dialog text analysis device according to the present invention.

FIG. 18 It depicts an explanatory view illustrating an example of a dialog text.

### DESCRIPTION OF EMBODIMENTS

Hereinafter, exemplary embodiments of the invention will be described with reference to the drawings.

### First Exemplary Embodiment

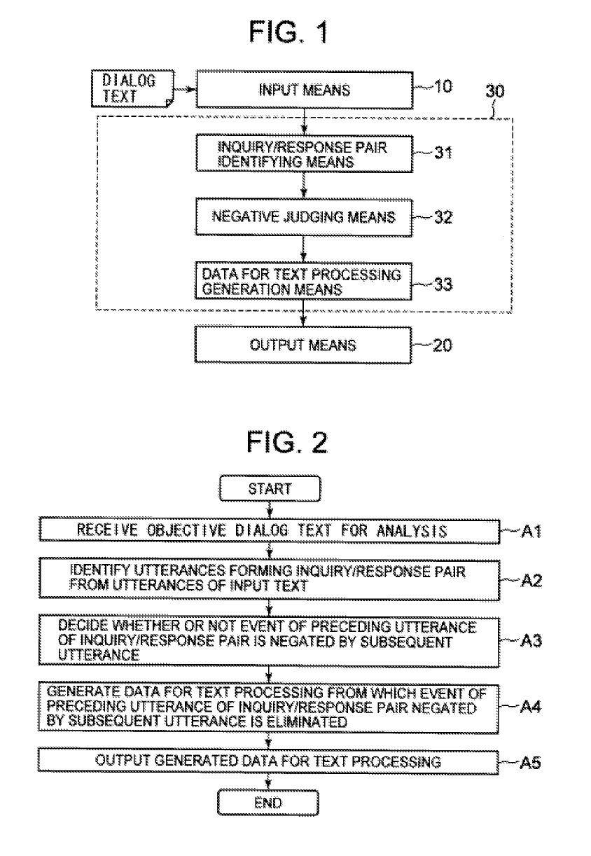

FIG. 1 depicts a block diagram illustrating an example of a dialog text analysis device according to a first exemplary embodiment of the present invention. The dialog text analysis device according to the present exemplary embodiment comprises input means 10, output means 20 and computer 30. Meanwhile, the computer 30 is realized by, for example, a central processing unit, a processor or a data processing device.

The input means 10 inputs to the computer 30 a text (that is, a dialog text) which includes content of a plurality of utterances as an object for analysis. Further, the output means 20 outputs data for text processing generated by the computer 30.

The computer 30 includes inquiry/response pair identifying means 31, negative judging means 32 and data for text processing generation means 33.

The inquiry/response pair identifying means 31 identifies from each utterance in the inputted dialog text a pair of utterances which has a relationship of an inquiry/response pair which is a pair of an utterance for asking to a speaker and an utterance which exists subsequent to this utterance and is a response to this utterance. In the following description, an utterance to ask to the speaker is referred to as a “preceding utterance”, and an utterance in response to this utterance is referred to as a “subsequent utterance”. The inquiry/response pair identifying means 31 may identify an utterance which represents a question and an immediate utterance as an inquiry/response pair. Further, the inquiry/response pair identifying means 31 may identify from a dialog text an adjacency pair determined based on a predetermined role as an inquiry/response pair.

The negative judging means 32 judges whether or not an event of the preceding utterance of the inquiry/response pair is negated by the subsequent utterance. The event is information which can be represented by a syntactic tree of utterances or a structure around a verb (a modification relation, a case structure and a subtree of a syntactic tree). When, for example, a predetermined utterance (referred to as a “negative utterance” below) which negates content of a preceding utterance and a subsequent utterance match, the negative judging means 32 may decide that the event of the preceding utterance of the inquiry/response pair is negated by the subsequent utterance. In addition, when a feature of a negative utterance and a feature of a subsequent utterance match, the negative judging means 32 may decide that the event of the preceding utterance is negated by the subsequent utterance. Meanwhile, a deciding method of the negative judging means 32 is not limited to these methods.

When the event of the preceding utterance is negated by the subsequent utterance, the data for text processing generation means 33 generates, as data for text processing, data in which the negated event of the preceding utterance is eliminated from the dialog text.

In addition, in the present invention, a fact means not only a matter which actually happens but also information which includes tentative content factuality of which can change in subsequent processing and content which does not actually happen (that is, content different from content which actually happens). For example, a fact which is decided to be an “affirmative fact” at a point of time when factuality of an event is focused upon can also be decided as a “negative fact” in subsequent processing.

In addition, the inquiry/response pair identifying means 31, the negative judging means 32 and the data for text processing generation means 33 are realized by the computer 30 (more specifically, the CPU of the computer 30) which operates according to a program (dialog text analysis program). For example, the program is stored in a memory unit (not illustrated) of the dialog text analysis device. The CPU may read the program from the memory unit, and operate as the inquiry/response pair identifying means 31, the negative judging means 32 and the data for text processing generation means 33 according to the program. Further, the inquiry/response pair identifying means 31, the negative judging means 32 and the data for text processing generation means 33 may each be realized by dedicated hardware.

Next, an operation of the dialog text analysis device will be described. FIG. 2 depicts a flowchart illustrating an example of an operation of the dialog text analysis device according to the first exemplary embodiment. The input means 10 receives an objective dialog text for analysis (step A1). Subsequently, the inquiry/response pair identifying means 31 identifies utterances forming the inquiry/response pair from utterances of the inputted dialog text a pair (inquiry/response pair) of an utterance to ask to a speaker and an utterance which exists subsequent to this utterance and is a response to this utterance (step A2).

The negative judging means 32 judges whether or not an event of the preceding utterance in the inquiry/response pair is negated by the subsequent utterance (step A3).

The data for text processing generation means 33 generates data for text processing which is used to perform text processing such as analysis like mining or search which is subsequently performed. More specifically, the data for text processing generation means 33 receives a decision result in step A3 (that is, whether or not the subsequent utterance of the inquiry/response pair negates the event of the preceding utterance) from the negative judging means 32. Further, when deciding that the event of the preceding utterance in the inquiry/response pair is negated by the subsequent utterance, the data for text processing generation means 33 generates data for text processing in which the negated event is eliminated from the dialog text (step A4). That is, the data for text processing generation means 33 can eliminate the event of the preceding utterance which exists before the event is negated by the subsequent utterance, as the negated event from the dialog text. Finally, the output means 20 outputs the data for text processing generated in step A4 (step A5).

As described above, in the present exemplary embodiment, the negative judging means 32 judges whether or not the event of the preceding utterance in the dialog text is negated by the subsequent utterance which exists subsequent to the preceding utterance. Further, when the event of the preceding utterance is negated by the subsequent utterance, the data for text processing generation means 33 generates data for text processing in which the negated event of the preceding utterance is eliminated from the dialog text. Consequently, it is possible to generate from the dialog text the data for text processing for which text processing such as analysis such as mining or search is precisely performed.

That is, in step A4, the data for text processing generation means 33 eliminates the event that the event of the preceding utterance in the inquiry/response pair is negated by the subsequent utterance, from the data for text processing. Consequently, it is possible to delete a tentative event in the preceding utterance in the dialog text or an event which is negated as a result of communication of the inquiry/response pair, from the data for text processing, and generate data for text processing which matches with a final conclusion. As a result, the data for text processing to be generated becomes data for which text processing such as analysis like mining or search can be precisely performed.

### Second Exemplary Embodiment

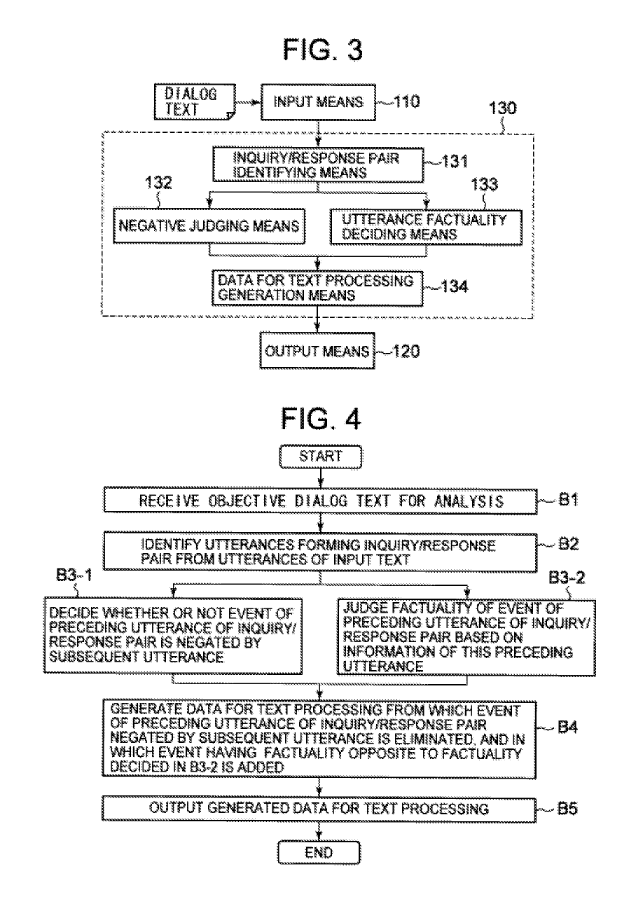

FIG. 3 depicts a block diagram illustrating an example of a dialog text analysis device according to a second exemplary embodiment of the present invention. The dialog text analysis device according to the present exemplary embodiment comprises input means 110, output means 120 and computer 130. The computer 130 is realized by, for example, a central processing unit, a processor or a data processing device. In addition, the input means 110 and the output means 120 are the same as an input means 10 and an output means 20 according to the first exemplary embodiment, and will not be described.

The computer 130 includes inquiry/response pair identifying means 131, negative judging means 132, intra-utterance factuality deciding means 133 and data for text processing generation means 134. The inquiry/response pair identifying means 131 and the negative judging means 132 are the same as an inquiry/response pair identifying means 31 and a negative judging means 32 according to the first exemplary embodiment, and will not be described.

The intra-utterance factuality deciding means 133 decides from information about a preceding utterance whether an event of the preceding utterance in an inquiry/response pair is an event which indicates an affirmative fact or an event which indicates a negative fact (that is, factuality of an event). The intra-utterance factuality deciding means 133 may decide the factuality of the event of the preceding utterance by, for example, using a model disclosed in Non Patent Literature 2.

When the event of the preceding utterance is negated by the subsequent utterance, the data for text processing generation means 134 generates, as data for text processing, data in which the negated event of the preceding utterance is eliminated from the dialog text, and the event which indicates factuality opposite to the factuality of the event of the preceding utterance is added to the dialog text. That is, when the event of the preceding utterance is negated by the subsequent utterance, if the event which is decided to be negated is an affirmative fact, the data for text processing generation means 134 changes this event to a negative fact, and, if the fact which is decided to be negated is the negative fact, changes this event to the affirmative fact, and adds the fact to the data for text processing instead of the negated event of the preceding utterance. The data for text processing generation means 134 may add information obtained by, for example, adding the factuality of the event to the event of the preceding utterance, to the data for text processing.

In addition, the inquiry/response pair identifying means 131, the negative judging means 132, the intra-utterance factuality deciding means 133 and the data for text processing generation means 134 may be realized by a computer 130 (more specifically, a CPU of the computer 130) which operates according to a program (dialog text analysis program). Further, the inquiry/response pair identifying means 131, the negative judging means 132, the intra-utterance factuality deciding means 133 and the data for text processing generation means 134 may each be realized by dedicated hardware.

Next, an operation of the dialog text analysis device will be described. FIG. 4 depicts a flowchart illustrating an example of the operation of the dialog text analysis device according to the second exemplary embodiment. In addition, processing in steps B1 to B3-1 in which the input means 110 receives an input of a dialog text, the inquiry/response pair identifying means 131 identifies an inquiry/response pair and the negative judging means 132 judges whether or not an event of a preceding utterance is negated by a subsequent utterance is the same as processing in steps A1 to A3 in FIG. 2.

After the processing in step B2 is performed, the intra-utterance factuality deciding means 133 decides whether or not the event of the preceding utterance is an affirmative fact or a negative fact (that is, factuality) using the preceding utterance in the inquiry/response pair (step B3-2). In addition, the processing in step B3-2 may be performed at the same time as the processing in step B3-1, or may be performed before or after the processing in step B3-1.

Subsequently, the data for text processing generation means 134 generates data for text processing used to perform text processing such as analysis like mining or search which is subsequently performed. More specifically, the data for text processing generation means 134 receives a result which is decided in step B3-1 as to whether or not the subsequent utterance of the inquiry/response pair negates the event of the preceding utterance, from the negative judging means 132. Further, the data for text processing generation means 134 receives a decision result of factuality of the event of the preceding utterance which is decided in step B3-2, from the intra-utterance factuality deciding means 133.

When deciding that the event of the preceding utterance in the inquiry/response pair is negated by the subsequent utterance, the data for text processing generation means 134 eliminates the negated event from the dialog text. Further, the data for text processing generation means 134 adds an event which indicates factuality opposite to factuality of the event of the preceding utterance decided in step B3-2, to the data for text processing instead of the eliminated event. That is, when the event of the preceding utterance decided in step B3-2 is an affirmative fact, the data for text processing generation means 134 generates data for text processing indicating that this event is a negative fact, and, when the event is a negative fact, generates data for text processing indicating that this event is the affirmative fact (step B4). Finally, the output means 120 outputs the data for text processing generated in step B4 (step B5).

As described above, in the present exemplary embodiment, when content of a negated event of a preceding utterance indicates an affirmative fact, the data for text processing generation means 134 adds this event to data for text processing as an event which indicates a negative fact, and, when content of the event of the preceding utterance indicates a negative fact, adds this event to the data for text processing as an event which indicates an affirmative fact.

That is, in step B4, the data for text processing generation means 134 eliminates the event that the event of the preceding utterance in the inquiry/response pair is negated by the subsequent utterance, from the data for text processing. Further, the data for text processing generation means 134 adds an event which indicates factuality opposite to factuality of the event of the preceding utterance decided in step B3-2, to the data for text processing instead of the eliminated event. Consequently, it is possible to generate data for text processing to match with a final conclusion for a tentative event in the preceding utterance in the dialog text or an event which is negated as a result of communication of the inquiry/response pair. As a result, the data for text processing to be generated becomes data for which text processing such as analysis like mining or search can be precisely performed.

### Third Exemplary Embodiment

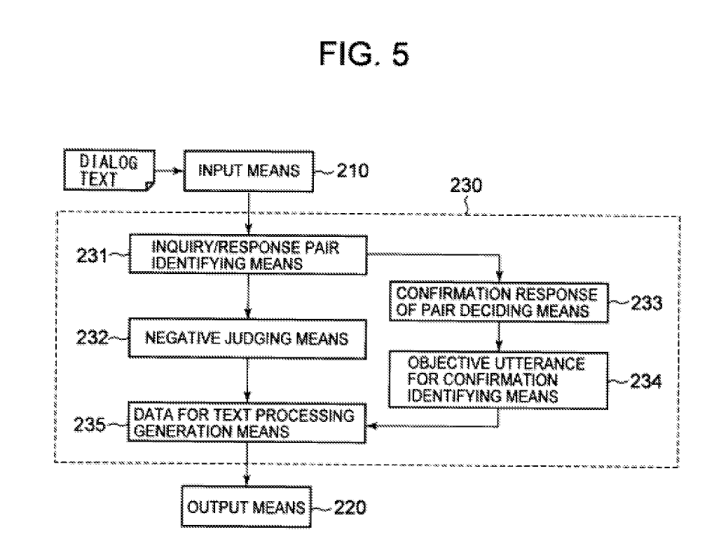

FIG. 5 depicts a block diagram illustrating an example of a dialog text analysis device according to a third exemplary embodiment of the present invention. The dialog text analysis device according to the present exemplary embodiment comprises input means 210, output means 220 and computer 230. The computer 230 is realized by, for example, a central processing unit, a processor or a data processing device. In addition, the input means 210 and the output means 220 are the same as an input means 10 and an output means 20 according to the first exemplary embodiment, and will not be described.

The computer 230 includes inquiry/response pair identifying means 231, negative judging means 232, confirmation response of pair deciding means 233, an objective utterance for confirmation identifying means 234 and a data for text processing generation means 235. The inquiry/response pair identifying means 231 and the negative judging means 232 are the same as an inquiry/response pair identifying means 31 and a negative judging means 32 according to the first exemplary embodiment, and will not be described.

The confirmation response of pair deciding means 233 decides whether or not a preceding utterance in an inquiry/response pair is an event which indicates confirmation or asking of a given event, and whether or not a subsequent utterance in this response pair is an event which indicates a response to the confirmation or the asking. Hereinafter, a pair of the inquiry/response pair which is the event that a preceding utterance indicates confirmation or asking and an event that a subsequent utterance indicates a response to the confirmation or the asking is referred to as a “confirmation (asking)-response” pair. More specifically, the confirmation response of pair deciding means 233 compares, for example, word similarity of the preceding utterance in the inquiry/response pair and each utterance in the dialog text which exists prior to this preceding utterance. Further, when an utterance of higher word similarity with the preceding utterance than a predetermined threshold exists prior to the preceding utterance, the confirmation response of pair deciding means 233 decides this response pair as the “confirmation (asking)-response” pair.

When the inquiry/response pair is the “confirmation (asking)-response” pair, the objective utterance for confirmation identifying means 234 identifies an utterance which is an objective utterance of the preceding utterance for confirmation or asking and is an utterance prior to the preceding utterance from utterances of the dialog text. In other words, it can also be said that, when the inquiry/response pair is the “confirmation (asking)-response” pair, the objective utterance for confirmation identifying means 234 identifies an utterance which causes confirmation or asking in the preceding utterance from utterances which exist prior to the preceding utterance among utterances in the dialog text. More specifically, the objective utterance for confirmation identifying means 234 may identify an utterance of higher word similarity with the preceding utterance than the threshold as the utterance which is an object (cause) of the preceding utterance for confirmation or asking.

When the event of the preceding utterance is negated by the subsequent utterance, the data for text processing generation means 235 generates, as data for text processing, data in which the negated event of the preceding utterance is eliminated from the dialog text, and the event of the utterance (that is, the utterance which causes confirmation or asking in the preceding utterance) identified by the objective utterance for confirmation identifying means 234 is eliminated from the dialog text.

In addition, the inquiry/response pair identifying means 231, the negative judging means 232, the confirmation response of pair deciding means 233, the objective utterance for confirmation identifying means 234 and the data for text processing generation means 235 are realized by the computer 230 (more specifically, the CPU of the computer 230) which operates according to a program (dialog text analysis program). Further, the inquiry/response pair identifying means 231, the negative judging means 232, the confirmation response of pair deciding means 233, the objective utterance for confirmation identifying means 234 and the data for text processing generation means 235 may be each realized by dedicated hardware.

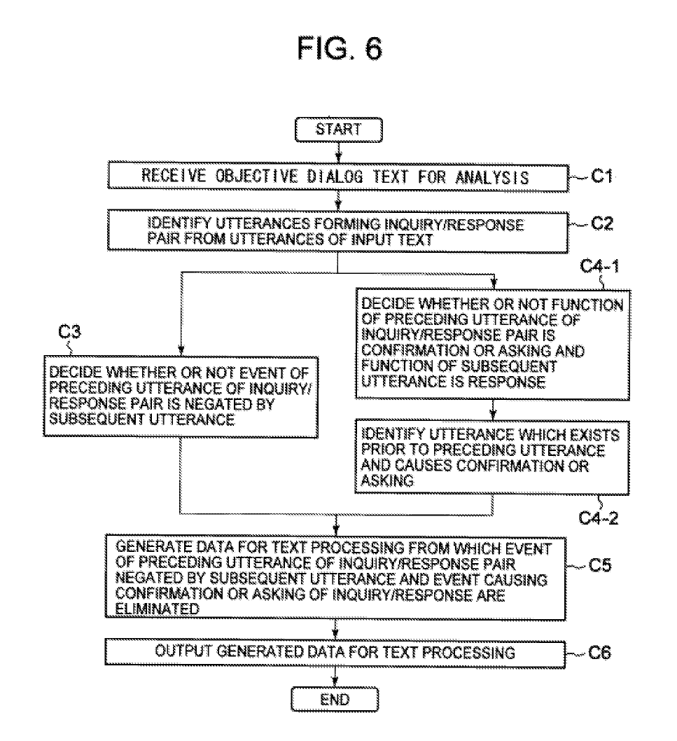

Next, an operation of the dialog text analysis device will be described. FIG. 6 depicts a flowchart illustrating an example of an operation of the dialog text analysis device according to the third exemplary embodiment. In addition, processing in steps C1 to C3 in which the input means 210 receives an input of a dialog text, the inquiry/response pair identifying means 231 identifies an inquiry/response pair and the negative judging means 232 judges whether or not an event of a preceding utterance is negated by a subsequent utterance is the same as processing in steps A1 to A3 in FIG. 2.

After the processing in step C2 is performed, the confirmation response of pair deciding means 233 decides whether or not a function of the preceding utterance of the inquiry/response pair is confirmation or asking, and a function of the subsequent utterance is a response to this preceding utterance (step C4-1). In addition, processing in step C4-1 may be performed at the same time as the processing in step C3, or may be performed before or after the processing in step C3.

When it is decided in step C4-1 that the inquiry/response pair is the “confirmation (asking)-response” pair, the objective utterance for confirmation identifying means 234 identifies from utterances of the dialog text an utterance which exists prior to the preceding utterance and which is an object of the preceding utterance for confirmation or asking (step C4-2).

Subsequently, the data for text processing generation means 235 generates data for text processing used to perform text processing such as analysis like mining or search which is subsequently performed. More specifically, the data for text processing generation means 235 receives a result which is decided in step C3 as to whether or not the subsequent utterance of the inquiry/response pair negates the event of the preceding utterance from the negative judging means 232. Further, the data for text processing generation means 235 receives an utterance which is identified in step C4-2 and which causes confirmation or asking by the inquiry/response pair, from the objective utterance for confirmation identifying means 234.

When deciding that the event of the preceding utterance in the inquiry/response pair is negated by the subsequent utterance, the data for text processing generation means 235 eliminates the negated event from the dialog text. Further, the data for text processing generation means 235 also eliminates an event of the utterance which causes confirmation or asking by this response pair (step C5). Finally, the output means 220 outputs the data for text processing generated in step C5 (step C6).

As described above, in the present exemplary embodiment, the confirmation response of pair deciding means 233 decides whether or not the inquiry/response pair has a relationship of a “confirmation (asking)-response” pair. When the inquiry/response pair has the relationship of the “confirmation (asking)-response” pair, the objective utterance for confirmation identifying means 234 identifies an utterance which causes confirmation or asking in the preceding utterance from utterances which exist prior to the preceding utterance among utterances in the dialog text. Further, when the event of the preceding utterance is negated by the subsequent utterance, the data for text processing generation means 235 generates data for text processing in which a fact of an event in the identified utterance of the cause is eliminated.

That is, in step C5, the data for text processing generation means 235 eliminates the event that the event of the preceding utterance in the inquiry/response pair is negated by the subsequent utterance, from the data for text processing. Further, the data for text processing generation means 235 also eliminates an event of the utterance which causes confirmation or asking by this response pair, from the data for text processing. Consequently, factuality of an event the factuality of which is determined once is changed depending on subsequent confirmation or asking or a response by an inquiry/response pair, so that it is possible to eliminate an event which is different from a final conclusion, from the data for text processing. As a result, the data for text processing to be generated becomes data for which text processing such as analysis like mining or search can be precisely performed.

### Fourth Exemplary Embodiment

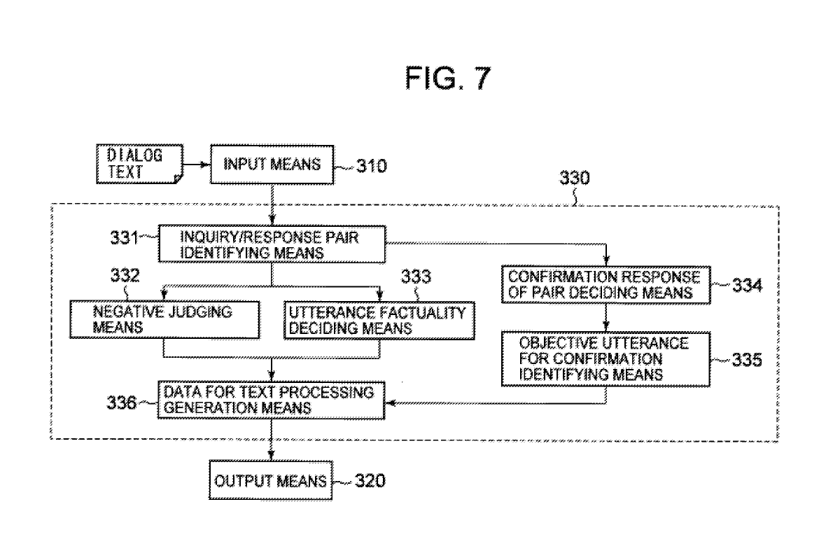

FIG. 7 depicts a block diagram illustrating an example of a dialog text analysis device according to a fourth exemplary embodiment of the present invention. The dialog text analysis device according to the present exemplary embodiment comprises input means 310, output means 320 and computer 330. Meanwhile, the computer 330 is realized by, for example, a central processing unit, a processor or a data processing device. In addition, the input means 310 and the output means 320 are the same as an input means 10 and an output means 20 according to the first exemplary embodiment, and will not be described.

The computer 330 includes inquiry/response pair identifying means 331, negative judging means 332, intra-utterance factuality deciding means 333, confirmation response of pair deciding means 334, objective utterance for confirmation identifying means 335 and data for text processing generation means 336. The inquiry/response pair identifying means 331, the negative judging means 332 and the intra-utterance factuality deciding means 333 are the same as an inquiry/response pair identifying means 131, a negative judging means 132 and an intra-utterance factuality deciding means 133 according to a second exemplary embodiment. Further, the confirmation response of pair deciding means 334 and the objective utterance for confirmation identifying means 335 are the same as a confirmation response of pair deciding means 233 and the objective utterance for confirmation identifying means 234 according to the third exemplary embodiment. Hence, content of these means will not be described.

When the event of a preceding utterance is negated by a subsequent utterance, the data for text processing generation means 336 generates, as data for text processing, data in which the negated event of the preceding utterance is eliminated from the dialog text, and the event which indicates factuality opposite to the factuality of the event of the preceding utterance is added to the dialog text.

Further, the data for text processing generation means 336 changes factuality of an event of the utterance (that is, an utterance which causes confirmation or asking of the preceding utterance) identified by the objective utterance for confirmation identifying means 335 to match with factuality of the event which is added to the dialog text. More specifically, when the event of the preceding utterance is negated by the subsequent utterance, if content of the event in the utterance which causes confirmation or asking in the preceding utterance indicates an affirmative fact, the data for text processing generation means 336 changes an event which indicates this affirmative fact to an event which indicates a negative fact and adds the event to data for text processing. Similarly, when content of the event which causes confirmation or asking in the preceding utterance indicates the negative act, the data for text processing generation means 336 changes the event which indicates the negative fact to the event which indicates the affirmative fact and adds the event to the data for text processing. In addition, a method of adding an event which indicates factuality opposite to factuality of an event to a dialog text is the same as a method of a data for text processing generation means 134 of adding an event which indicates factuality opposite to factuality of an event of the preceding utterance to the dialog text.

The inquiry/response pair identifying means 331, the negative judging means 332, the intra-utterance factuality deciding means 333, the confirmation response of pair deciding means 334, the objective utterance for confirmation identifying means 335 and the data for text processing generation means 336 are realized by the computer 330 (more specifically, a CPU of the computer 330) which operates according to a program (dialog text analysis program). Further, the inquiry/response pair identifying means 331, the negative judging means 332, the intra-utterance factuality deciding means 333, the confirmation response of pair deciding means 334, the objective utterance for confirmation identifying means 335 and the data for text processing generation means 336 may be each realized by dedicated hardware.

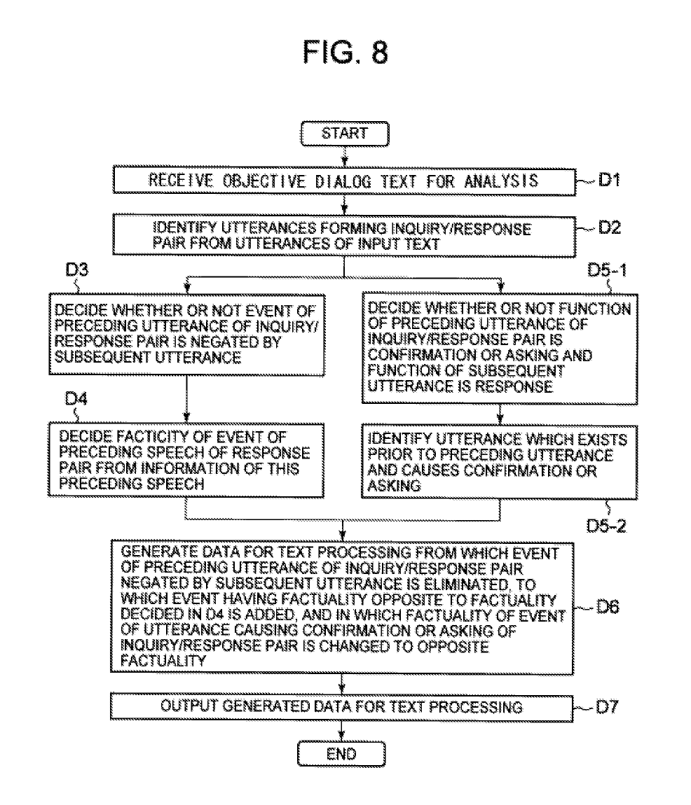

Next, an operation of the dialog text analysis device will be described. FIG. 8 depicts a flowchart illustrating an example of an operation of the dialog text analysis device according to the fourth exemplary embodiment. In addition, processing in steps D1 to D2 in which the input means 310 receives an input of a dialog text, and the inquiry/response pair identifying means 331 identifies an inquiry/response pair is the same as processing in steps B1 and B2 in FIG. 4.

Subsequently, the negative judging means 332 judges whether or not an event of the preceding utterance is negated by the subsequent utterance. Processing in steps D3 and D4 in which the intra-utterance factuality deciding means 333 decides factuality of the preceding utterance is the same as processing in steps B3-1 to B3-2 in FIG. 4. Further, processing in steps D5-1 and D5-2 in which the confirmation response of pair deciding means 334 decides whether or not an inquiry/response pair is a “confirmation (asking)-response” pair and the objective utterance for confirmation identifying means 335 identifies an utterance which is an object of the preceding utterance for confirmation or asking is the same as processing in steps C4-1 and C4-2 in FIG. 6.

In addition, as long as processing in step D5-2 is performed after processing in step D5-1, an order of processing in steps D3, D4, D5-1 and D5-2 is random.

Subsequently, the data for text processing generation means 336 generates data for text processing used to perform text processing such as analysis like mining or search which is subsequently performed. More specifically, the data for text processing generation means 336 receives a result which is decided in step D3 as to whether or not the subsequent utterance of the inquiry/response pair negates the event of the preceding utterance, from the negative judging means 332. Further, the data for text processing generation means 336 receives a decision result of factuality of the event of the preceding utterance which is decided in step D4, from the intra-utterance factuality deciding means 333. Furthermore, the data for text processing generation means 336 receives an utterance which is identified in step D5-2 and which causes confirmation or asking by the inquiry/response pair, from the objective utterance for confirmation identifying means 335.

When deciding that the event of the preceding utterance in the inquiry/response pair is negated by the subsequent utterance, the data for text processing generation means 336 eliminates the negated event from the dialog text. Further, the data for text processing generation means 336 adds an event which indicates factuality opposite to factuality of the event of the preceding utterance decided in step D4, to the data for text processing instead of the eliminated event. Furthermore, the data for text processing generation means 336 also changes factuality of the event of the utterance which causes confirmation or asking by this response pair to match with factuality of the added event (step D6). Finally, the output means 320 outputs the data for text processing generated in step D6 (step D7).

As described above, in the present exemplary embodiment, in step D6, the data for text processing generation means 336 eliminates the event that the event of the preceding utterance in the inquiry/response pair is negated by the subsequent utterance, from the data for text processing. Further, the data for text processing generation means 336 adds an event which indicates factuality opposite to factuality of the event of the preceding utterance decided in step D4, to the data for text processing instead of the eliminated event. Furthermore, the data for text processing generation means 336 generates data for text processing by also changing factuality of the event of the utterance which causes confirmation or asking by this response pair to the opposite factuality (that is, changing the factuality to match with the factuality of the event added to the dialog text).

Consequently, even factuality of an event the factuality of which is determined once is changed depending on subsequent confirmation or asking or a response by an inquiry/response pair, so that it is also possible to generate data for text processing corrected to match with a final conclusion for an event which is different from the final conclusion. As a result, the data for text processing to be generated becomes data for which text processing such as analysis like mining or search can be precisely performed.

### Example 1

Exemplary examples of the present invention will be described below. In addition, the scope of the present invention is by no means limited to content described below. First, Example 1 of the present invention will be described. A dialog text analysis device according to Example 1 corresponds to a dialog text analysis device according to the first exemplary embodiment.

Process of generating data for text processing on a text which indicates communication at a call center made between a client and an operator illustrated in FIG. 18 will be described in the following example according to a flowchart illustrated in FIG. 2. In addition, as is clear from the example illustrated in FIG. 18, the objective communication text is a text in which an event in the communication text is determined or changed by a subsequent utterance. Further, the event is information which can be mechanically learned by a syntactic tree of utterances or a structure around a verb (a modification relation, a case structure and a subtree of a syntactic tree).

First, the input means 10 receives the dialog text illustrated in FIG. 18 as the input text. Meanwhile, the dialog text is partitioned per speech. In the example illustrated in FIG. 18, one speech index corresponds to an utterance.

Meanwhile, the dialog text is not limited to a text which is partitioned per utterance. Even when the text is not partitioned per utterance, a separator of utterances is set in advance, and a text which is divided as preprocessing at an appearance site of this separator only needs to be used as a dialog text. In addition, an example of the separator includes “.” (comma) or “?” (question mark).

Further, utterance data may be used for a source text. In this case, a text obtained by performing preprocessing of dividing data converted into a text using an utterance-recognition engine per utterance utilizing a silent interval detected by the utterance-recognition engine only needs to be used as a dialog text.

Further, as illustrated in FIG. 18, the dialog text may be assigned or may not be assigned information of a speaker of each utterance. In the example illustrated in FIG. 18, a tag which indicates that one of an operator or a client speaks is assigned to each utterance. Further, in addition to utterance content, the dialog text may be assigned information obtained from utterance such as prosodic information and time information of an utterance (the above is step A1).

Subsequently, an inquiry/response pair identifying means 31 identifies a pair of utterances which has a relationship of an inquiry/response pair from each utterance of an input text. The inquiry/response pair can be identified by, for example, identifying a pair of utterances of a question and a response to this question.

For example, the inquiry/response pair identifying means 31 first performs morphological analysis of each utterance, and decides whether or not an utterance is a question by matching a word for which morphological analysis is performed and a feature of the predetermined question. A feature of a question includes, for example, “an interrogative (adverbs or pre-noun adjectivals “why”, “what” and “whatever”)” or “end with sentence-ending particles such as auxiliary verbs “isn't it”, “is it” and “what””. Further, the inquiry/response pair identifying means 31 identifies as an inquiry/response pair a pair of an utterance which is decided to be a question and an immediate utterance.

The inquiry/response pair identifying means 31 may identify an adjacency pair as the inquiry/response pair. As disclosed in Non Patent Literature 3, the adjacency pair is a concept used in a world of conversation analysis. In the field of conversation analysis, a preceding utterance requests an utterance of a specific type, and, when a subsequent utterance is a response to the preceding utterance, these utterances are defined as an adjacency pair. Hence, the inquiry/response pair identifying means 31 may identify the adjacency pair based on the method disclosed in Non Patent Literature 3, and identify the identified adjacency pair as the inquiry/response pair.

Further, the inquiry/response pair identifying means 31 may identify the adjacency pair using a method disclosed in Non Patent Literature 4. In addition, by using the method disclosed in Non Patent Literature 4, it is possible to identify a type of utterances which form an adjacency pair (for example, the preceding utterance is “request” and the subsequent utterance is “approval/denial”). Meanwhile, the inquiry/response pair identifying means 31 may not identify a type of utterances or may identify a pair of utterances which is an adjacency pair.

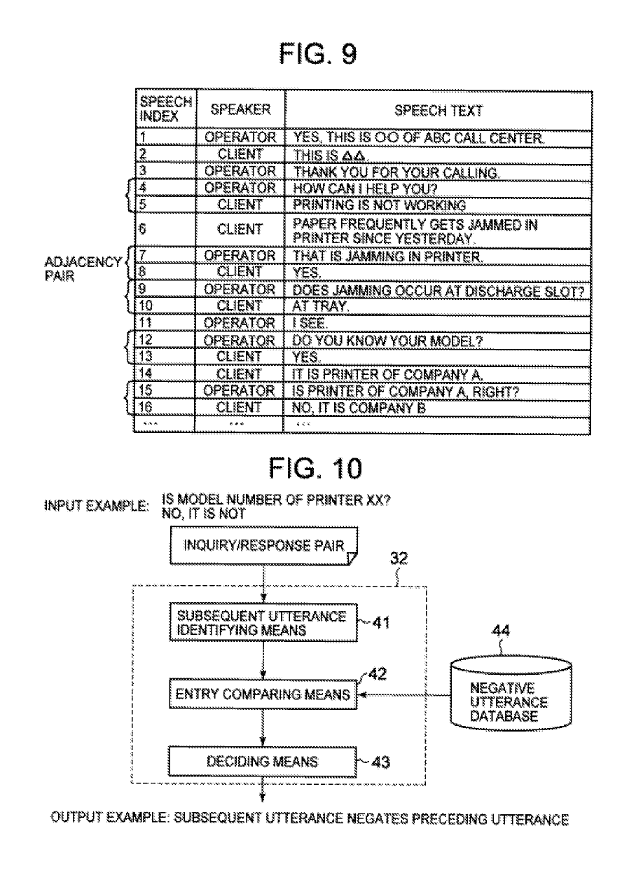

FIG. 9 is an explanatory view illustrating an example of an adjacency pair identified based on a dialog text illustrated in FIG. 18. In addition, the type of speeches is not identified in the adjacency pair illustrated in FIG. 9. In the example illustrated in FIG. 9, speeches identified by speech indices “4” and “5”, speech indices “7” and “8”, speech indices “9” and “10”, speech indices “12” and “13” and speech indices “15” and “16” are adjacency pairs. The inquiry/response pair identifying means 31 identifies a pair of speeches which have a relationship of an inquiry/response pair by learning such an adjacency pair as an inquiry/response pair (the above is step A2).

Subsequently, the negative judging means 32 judges whether or not an event of a preceding utterance in the inquiry/response pair is negated by a subsequent utterance. FIG. 10 depicts a block diagram illustrating an example of the negative judging means 32. The negative judging means 32 illustrated in FIG. 10 includes subsequent utterance identifying means 41, entry comparing means 42 and deciding means 43. Further, an utterance (that is, a negative utterance) which negates content of a preceding utterance and information which defines in advance a feature (rule) of this negative utterance are registered in the negative utterance database 44. For example, predetermined utterances such as utterances consisted only of negative auxiliary verbs and ancillary words or words consisted only of negative words and ancillary words only need to be registered in the negative utterance database 44 as part of negative utterances. For example, the negative utterance database 44 may be stored in, for example, a magnetic disk which a dialog text analysis device has or may be stored in a device which is different from the dialog text analysis device.

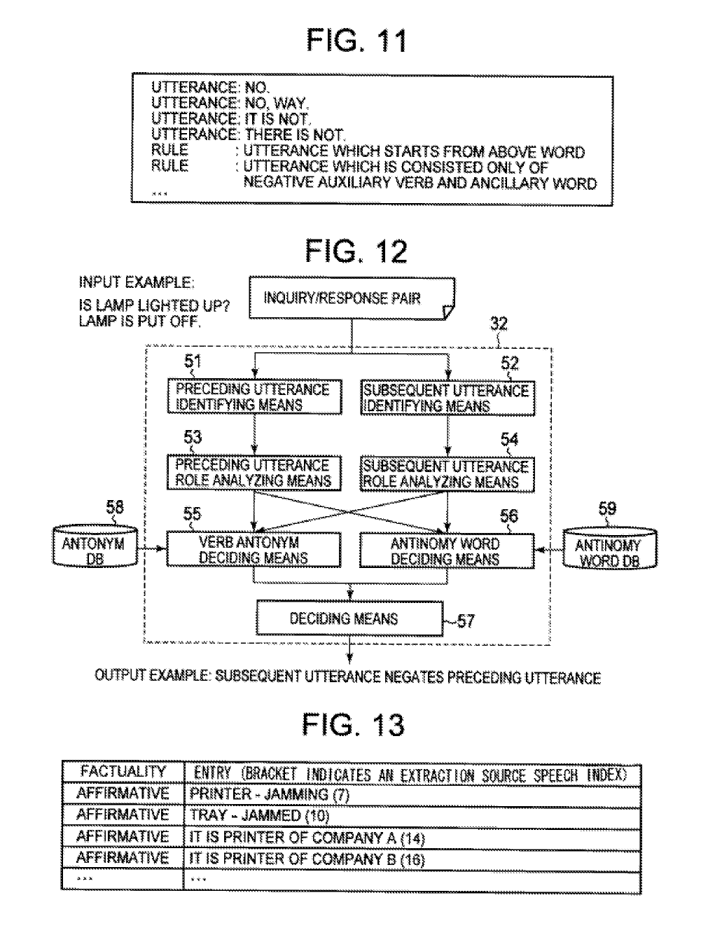

FIG. 11 depicts an explanatory view illustrating an example of information stored in a negative utterance database. In an example illustrated in FIG. 11, utterances “No.”, “No way.”, “No, It is not.” and “No, there is not” are stored as negative utterances, and utterances which start from phrases of utterances registered as negative utterances and utterances which are consisted only of negative auxiliary verbs and ancillary words are stored as rules of negative utterances.

When an inquiry/response pair is inputted to the negative judging means 32, the subsequent utterance identifying means 41 identifies an utterance which comes subsequently in a responses pair as a subsequent utterance. In the example illustrated in FIG. 10, when a pair of “Is a model number of a printer XX?” and “No, it is not.” is inputted as an inquiry/response pair, the subsequent utterance identifying means 41 identifies “No, it is not.” as a subsequent utterance.

The entry comparing means 42 reads data of the negative utterance database 44, compares the subsequent utterance and each entry of the negative utterance database, and decides whether or not match of an entry found in the database exists. In the examples illustrated in FIGS. 10 and 11, the entry comparing means 42 decides that the subsequent utterance “No, it is not.” exists in the third entry from the top in the negative utterance database (matches with an entry). In this case, the entry comparing means 42 may decide that the subsequent utterance “No, it is not.” matches with a feature (rule) of a negative utterance which exists in the fifth entry from the top in the negative utterance database.

When the entry corresponding to the subsequent utterance exists in the negative utterance database 44, the deciding means 43 decides that an event of the preceding utterance in the inquiry/response pair is negated by the subsequent utterance. More specifically, when the negative utterance matches with the subsequent utterance or when a feature of the negative utterance and a feature of the subsequent utterance match, the deciding means 43 decides that the event of the preceding utterance is negated by the subsequent utterance. In the examples illustrated in FIGS. 10 and 11, the negative utterance and the subsequent utterance match, so that the deciding means 43 decides that the event of the preceding utterance is negated by the subsequent utterance.

Although a case has been described above where the negative judging means 32 employs a configuration including the subsequent utterance identifying means 41, the entry comparing means 42 and the deciding means 43, the configuration of the negative judging means 32 is not limited to the configuration illustrated in FIG. 10.

FIG. 12 depicts a block diagram illustrating another example of the negative judging means 32. The negative judging means 32 illustrated in FIG. 12 includes preceding utterance identifying means 51, subsequent utterance identifying means 52, preceding utterance role analyzing means 53, subsequent utterance role analyzing means 54, verb antonym deciding means 55, antinomy word deciding means 56 and a deciding means 57. Further, an antonym pair of verbs created in advance is registered in an antonym database 58 (referred to as the “antonym DB 58” below). Furthermore, an antinomy word pair created in advance is registered in an antinomy word database 59 (referred to as the “antinomy word DB 59” below). For example, the antonym DB 58 and the antinomy word DB 59 may be stored in, for example, a magnetic disk which a dialog text analysis device has or may be stored in a device which is different from the dialog text analysis device.

The preceding utterance identifying means 51 identifies an utterance which comes earlier in an inquiry/response pair as a preceding utterance. Further, the subsequent utterance identifying means 52 identifies an utterance which subsequently comes in the inquiry/response pair as a subsequent utterance. In an example illustrated in FIG. 12, when a pair of “Is a lamp lighted up?” and “The light is put off.” is inputted as an inquiry/response pair, the preceding utterance identifying means 51 identifies “Is a lamp lighted up?” as a preceding utterance, and the subsequent utterance identifying means 52 identifies “The light is put off.” as the subsequent utterance.

The preceding utterance role analyzing means 53 analyzes a role of each element of the preceding utterance in a sentence. Likewise, the subsequent utterance role analyzing means 54 analyzes a role of each element of the subsequent utterance in a sentence. The preceding utterance role analyzing means 53 and the subsequent utterance role analyzing means 54 may analyze a grammatical role of a sentence such as “subject”, “predicate” or “object” as a role in a sentence. In addition, a role in a sentence to be analyzed is not limited to a grammatical role of the sentence. The preceding utterance role analyzing means 53 and the subsequent utterance role analyzing means 54 may analyze surface cases such as “ga case”, “ha case” and “de case” in case of Japanese or may analyze deep cases such as “agent”, “instrument” and “object”.

In this case, the preceding utterance role analyzing means 53 and the subsequent utterance role analyzing means 54 may analyze a grammatical role by applying, for example, HPSG (Head-Driven Phrase Structure Grammar) which is a grammatical rule to a sentence. In addition, the preceding utterance role analyzing means 53 and the subsequent utterance role analyzing means 54 may analyze a verb and a surface case of the verb using a KNP which is a Japanese analyzer which is available for free.

The verb antonym deciding means 55 decides whether or not verbs of the preceding utterance and the subsequent utterance are antonyms. By, for example, using the antonym DB 58 which stores antonym pairs of verbs created in advance, the verb antonym deciding means 55 may decide that verbs of these utterances are antonyms when information corresponding to the verb of the preceding utterance and the verb of the subsequent utterance exists in the antonym pair in the database. In the example illustrated in FIG. 12, the verb of the preceding utterance is “lighted up”, and the verb of the subsequent utterance is “is put off”. When this antonym pair is stored in the antonym DB 58, the verb antonym deciding means 55 decides that these verbs are antonyms.

Further, by using a result of performing morphological analysis of the preceding utterance and the subsequent utterance, the verb antonym deciding means 55 may decide that verbs of these utterances are antonyms even when the verb of the subsequent utterance matches with the preceding utterance and this verb is denied by a negative auxiliary verb (such as “no”) in the subsequent utterance. For example, the verb of the preceding utterance is “lighted up”, and the subsequent utterance is “is not lighted up”. In this case, the verbs “lighted” of the preceding utterance and the subsequent match and this verb is negated in the subsequent utterance, and the verb antonym deciding means 55 decides that the verbs of these utterances are antonyms.

The antinomy word deciding means 56 decides whether or not elements having the same role in the preceding utterance and the subsequent utterance are an antinomy. The antinomy of the two elements means that the two elements do not simultaneously hold. That is, when one element cannot be the other element, these two elements are referred to as “antinomy”. By, for example, using the antinomy word DB 59 which stores antinomy word pairs created in advance, the antinomy word deciding means 56 may decide that these elements are an antinomy when elements having the same roles as the preceding utterance and the subsequent utterance exist as an antinomy word pair in a database.

Further, the antinomy word deciding means 56 may decide that a pair of nodes which exists in the same class and has the same parent node in a word thesaurus which adopts hierarchical structure are antinomy words. For example, an inquiry/response pair inputted to the negative judging means 32 is a pair of speech indices “9” and “10” illustrated in FIG. 9. In this case, the preceding speech role analyzing means 53 analyzes a de case element of the preceding speech (speech index “9”) as a “discharge slot”, and the subsequent speech role analyzing means 54 analyzes a de case element of the subsequent speech (speech index “10”) as a “tray”. When a “printer” is a parent node as a component of a printer in the word thesaurus and the “discharge slot” and the “tray” exist in the same class, the antinomy word deciding means 56 compares the “discharge slot” and the “tray” which are de case elements having the same role in the preceding speech and the subsequent speech, and decides that this word pair is antinomy words.

Similarly, when an inquiry/response pair inputted to the negative judging means 32 is a pair of speech indices “15” and “16” illustrated in FIG. 9, the antinomy word deciding means 56 compares a “printer of company A” and “(a printer of) company B” which are the same deep case “agent” in the preceding speech and the subsequent speech, and decides that this response pair is antinomy words.

When a verb used in the subsequent utterance in the inquiry/response pair is an antonym of the verb used in the preceding utterance and the other elements match or when part of elements used in the subsequent utterance are antinomy of elements which have the same role in the preceding utterance and are used, the deciding means 57 decides that the event of the preceding utterance is negated by the subsequent utterance.

As described above, a pair of “Is a lamp lighted up?” and “The lamp is put out.” illustrated in FIG. 12 satisfies a decision criterion that the verb used in the subsequent speech in the inquiry/response pair is an antonym of the verb used in the preceding speech and the other elements match. Further, the pair of the speech indices “9” and “10” and the pair of the speech indices “15” and “16” illustrated in FIG. 9 also satisfy a decision criterion that part of elements used in the subsequent speeches are antinomy of elements which have the same role in the preceding speech and are used. Hence, the deciding means 57 decides for each response pair that the event of the preceding speech is negated by the subsequent speech (the above is step A3).

Subsequently, the data for text processing generation means 33 generates the data for text processing by eliminating the event that the event of the preceding speech in the inquiry/response pair is negated by the subsequent speech. For example, as described above, the negative judging means 32 decides for the pair of the speech indices “9” and “10” illustrated in FIG. 9 and the pair of the speech indices “15” and “16” that the event of the preceding speech is negated by the subsequent speech. In this case, the data for text processing generation means 33 generates data for text processing by eliminating from the dialog text the event of the speech index “9” and the event of the speech index “15”.

In addition, the data for text processing can adopt various formats depending on a type of the following text processing. For example, the data for text processing generation means 33 may divide each utterance of an input text (dialog text) into elements of units (a morpheme, a morpheme n gram, a modification, a segment, an utterance or a combination of these) used in subsequent text processing, and generate an element list as data for text processing.

FIG. 13 depicts an explanatory view illustrating an example of data for text processing generated in modification units as an element. In addition, a bracket attached to an entry illustrated in FIG. 13 indicates an extraction source speech index. In the example illustrated in FIG. 13, a value which indicates an affirmative fact or a negative fact is assigned to each element of data. Thus, the data for text processing generation means 33 may generate data for text processing including a value which indicates the affirmative fact or the negative fact in each element of data. Further, as illustrated in FIG. 13, from the data for text processing, a fact corresponding to the event that “Jamming occurs at a discharge slot” or “It is a printer of company A” which is negated by a subsequent speech of an inquiry/response pair is eliminated (the above is step A4).

Finally, the output means 20 outputs the data for text processing generated by the data for text processing generation means 33 (step A5).

As described above, in the dialog text analysis device according to the present example, in processing in step A4, factuality of the event of the preceding utterance of the inquiry/response pair is determined by the subsequent utterance, so that it is possible to eliminate the event which is different from a final conclusion form the data for text processing.

When, for example, the dialog text illustrated in FIG. 9 is inputted, the event that “Jamming occurs at a discharge slot” is in a hypothetical state at a point of time when an utterance of the speech index “9” is made. It is found that, when this event is negated by the utterance of the speech index “10”, the fact that “Jamming occurs at a discharge slot” does not hold finally.

In the dialog text analysis device according to the present example, the negative judging means 32 can judge that the event of the utterance of the speech index “9” is negated by the subsequent speech of this response pair. Further, the data for text processing generation means 33 generates data for text processing from which an element corresponding to the event that “Jamming occurs at a discharge slot” is eliminated. Hence, the generated data for text processing becomes data which matches with the final conclusion. That is, the generated data for text processing becomes data for which text processing such as analysis like mining or search can be precisely performed as a result.

For example, a case that “Jamming occurs at a discharge slot” is searched in subsequent analysis. In this case, from the data for text processing generated from the dialog text illustrated in FIG. 9, an element corresponding to an event that “Jamming occurs at a discharge slot” is eliminated. Consequently, even when the case that “Jamming occurs at a discharge slot” is searched, a match of the case is not found in the dialog text illustrated in FIG. 9, so that it is possible to perform accurate search.

### Example 2

Next, Example 2 of the present invention will be described. A dialog text analysis device according to Example 2 corresponds to a dialog text analysis device according to the second exemplary embodiment. A text which indicates communication at a call center made between a client and an operator illustrated in FIG. 18 will also be an object in the following description. Further, process of creating data for text processing will be described according to the flowchart illustrated in FIG. 4.

In addition, processing in steps B1 to B3-1 in FIG. 4 in which an input means 110 receives an input of a dialog text, the inquiry/response pair identifying means 131 identifies an inquiry/response pair and the negative judging means 132 judges whether or not an event of a preceding utterance is negated by a subsequent utterance is the same as processing in steps A1 to A3 in FIG. 2, and will not be described.

After the processing in step B2 is performed, an intra-utterance factuality deciding means 133 decides whether or not the event of the preceding speech is an affirmative fact or a negative fact (that is, factuality) using the preceding speech in the inquiry/response pair. In addition, the processing in step B3-2 may be performed at the same time as the processing in step B3-1, or may be performed before or after the processing in step B3-1. The intra-utterance factuality deciding means 133 may decide the factuality of the event of the preceding speech by, for example, using a factuality deciding method disclosed in Non Patent Literature 2. For example, an event of a speech index “9” illustrated in FIG. 9 and an event of a speech index “15” are decided as affirmative facts (the above is step B3-2).

When deciding that the event of the preceding speech in the inquiry/response pair is negated by the subsequent speech, the data for text processing generation means 134 eliminates the negated event from the dialog text. Further, the data for text processing generation means 134 adds an event which indicates factuality opposite to factuality of the event of the preceding speech decided in step B3-2, to the generate instead of the eliminated event. For example, in step B3-1, the negative judging means 132 judges for the pair of the speech indices “9” and “10” illustrated in FIG. 9 and the pair of the speech indices “15” and “16” that the event of the preceding speech is negated by the subsequent speech. In this case, the data for text processing generation means 134 eliminates from the dialog text the event of the speech index “9” and the event of the speech index “15” which exist as the affirmative facts. Further, the data for text processing generation means 134 generates data for text processing by adding to the dialog text an event such as “Jamming occurs at a discharge slot” or “It is a printer of company A” as a negative fact instead of the eliminated fact.

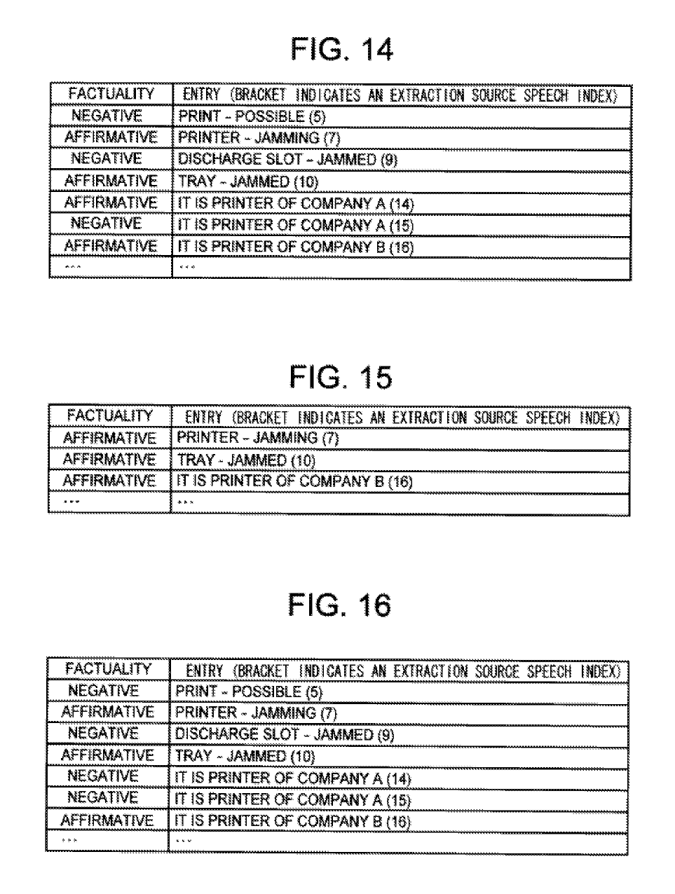

FIG. 14 depicts an explanatory view illustrating an example of data for text processing generated by the data for text processing generation means 134. In addition, a bracket attached to an entry illustrated in FIG. 14 indicates an extraction source speech index. In an example illustrated in FIG. 14, the negative fact that “Jamming occurs at a discharge slot” or “It is a printer of company A” is added to the data for text processing (the above is step B4).

Finally, the output means 120 outputs the data for text processing generated by the data for text processing generation means 134 (step B5).

As described above, in the processing in step B4, the dialog text analysis device according to the present example can generate data for text processing which is changed such that a tentative event in a preceding utterance in an inquiry/response pair or the event which is negated as a result of communication of an inquiry/response pair matches with a final conclusion.

When, for example, the dialog text illustrated in FIG. 9 is inputted, the event of the speech index “9” that “Jamming occurs at a discharge slot” is negated by an utterance of a speech index “10” and is finally replaced with a negative fact. That is, the affirmative fact that “Jamming occurs at a discharge slot” which is a tentative event at a point of time when the utterance of the speech index “9” is made, and the event that “Jamming occurs at a discharge slot” can be included in data for text processing as a negative fact. Consequently, it is possible to generate data for text processing which matches with a final conclusion. That is, the generated data for text processing becomes data for which text processing such as analysis like mining or search can be precisely performed as a result.

For example, a case that “Jamming occurs at a discharge slot” and a case that “Jamming does not occur at a discharge slot” are searched in subsequent analysis. In this case, in the data for text processing generated from the dialog text illustrated in FIG. 9, information indicating that “Jamming occurs at a discharge slot” is a negative fact is included. Consequently, even when the case that “Jamming occurs at a discharge slot” is searched, the dialog text illustrated in FIG. 9 does not appear in a search result. Meanwhile, when a case that “Jamming does not occur at a discharge slot” is searched, the dialog text illustrated in FIG. 9 appears in the search result, so that it is possible to perform accurate search.

### Example 3

Next, Example 3 of the present invention will be described. A dialog text analysis device according to Example 3 corresponds to a dialog text analysis device according to the third exemplary embodiment. A text which indicates communication at a call center between a client and an operator illustrated in FIG. 18 will also be an object in the following description. Further, process of creating data for text processing will be described according to the flowchart illustrated in FIG. 6.

In addition, processing in steps C1 to C3 in FIG. 6 in which an input means 210 receives an input of a dialog text, the inquiry/response pair identifying means 231 identifies an inquiry/response pair and the negative judging means 232 judges whether or not an event of a preceding utterance is negated by a subsequent utterance is the same as processing in steps A1 to A3 in FIG. 2, and will not be described.

After the processing in step C2 is performed, a confirmation response of pair deciding means 233 decides whether or not a function of the preceding utterance of the inquiry/response pair is confirmation or asking, and a function of the subsequent utterance is a response (step C4-1). In addition, processing in step C4-1 may be performed at the same time as the processing in step C3, or may be performed before or after the processing in step C3.

More specifically, the confirmation response of pair deciding means 233 compares a preceding utterance in an inquiry/response pair and each utterance in a dialog text which exists prior to this preceding utterance, and, when an utterance of an included higher word similarity than a predetermined threshold exists, decides that the preceding utterance is an event which indicates confirmation or asking and the subsequent utterance of this response pair is an event which indicates a response.

Decision processing on an inquiry/response pair of speech indices “15” and “16” illustrated in FIG. 9 will be described. The confirmation response of pair deciding means 233 compares the speech index “15” of the preceding speech and each speech (speech indices “1” to “14”) which appears prior to the speech index “15” in the dialog text.

In addition, although a case of comparison with all speeches which exist prior to the preceding speech will be described below, the utterances may be limited to speeches spaced a predetermined distance (number of items) apart from the preceding speech to compare. When, for example, comparison objects are limited to speeches up to distance 3 speeches, the confirmation response of pair deciding means 233 only needs to compare the speech index “15” and each speech of the speech indices “12” to “14”.

Further, when information about a speaker of each utterance is assigned to the inputted dialog text, the confirmation response of pair deciding means 233 may perform comparison by limiting utterances to utterances of a speaker different from a speaker of the preceding utterance. In the example illustrated in FIG. 9, a speaker of the preceding utterance (an utterance of the speech index “15”) is an operator, and therefore comparison objects may be limited to utterances spoken by speakers other than the operator. Further, the confirmation response of pair deciding means 233 may perform comparison by limiting utterances to utterances spoken by the same speaker as that of the subsequent utterance. In the example illustrated in FIG. 9, the speaker of the subsequent utterance (an utterance of the speech index “16”) is a client, and comparison objects may be limited to utterances spoken by the client.

The confirmation response of pair deciding means 233 calculates word similarity of each preceding utterance and the preceding utterance upon comparison. The confirmation response of pair deciding means 233 may calculate the similarity using, for example, a common word count or cosine similarity.

When the common word count (meanwhile, words are limited to content words) is used as the similarity, common words of the utterance of the speech index “14” and the preceding speech are two words of “company A” and “printer”, and therefore the similarity is 2. Similarly, a common word of the utterances of the speech indices “6” and “7” and the preceding speech is one word of “printer”, and the similarity is 1 and the similarity of the other speeches and the preceding speech is 0.

Further, when speeches of the calculated similarity equal to or more than a predetermined threshold exist, the confirmation response of pair deciding means 233 decides that the preceding speech is an event which indicates confirmation or asking, and decides that the subsequent speech is an event which indicates a response. When, for example, the threshold is set to 2 in the above example, the confirmation response of pair deciding means 233 decides that the utterance of the speech index “15” is an event which indicates confirmation or asking and decides that the utterance of the speech index “16” is an event which indicates a response of the speech index “15”.

In addition, confirming or asking is rarely away from a confirmation or asking object. Hence, a threshold may be set such that the threshold is greater when the preceding utterance is placed spaced farther apart (that is, the threshold is proportional to the distance from the preceding utterance) (the above is step C4-1).

When it is decided as a result of processing in step C4-1 that an inquiry/response pair is a “confirmation (asking)-response” pair, the objective utterance for confirmation identifying means 234 identifies an objective utterance which causes a confirmation or asking by the inquiry/response pair. More specifically, the objective utterance for confirmation identifying means 234 identifies an utterance of higher word similarity with the preceding speech calculated in step C4-1 than the threshold as the utterance which is an object (cause) of the preceding speech for confirmation or asking. In case of, for example, in step C4-1, the objective utterance for confirmation identifying means 234 identifies an utterance of the speech index 14 which has word similarity which is a threshold 2 or more as the utterance which is an object (cause) of the preceding speech for confirmation or asking.

Subsequently, the data for text processing generation means 235 generates the data for text processing in which not only the event that the event of the preceding utterance in the inquiry/response pair is negated by the subsequent utterance but also the event of the utterance which causes confirmation or asking by the inquiry/response pair are eliminated.

In, for example, the example illustrated in FIG. 9, the utterance of the speech index “14” is confirmed (asked) by the utterance of the speech index “15”, and the utterance of the speech index “15” is negated by the subsequent speech (the utterance of the speech index “16”) in the inquiry/response pair. Hence, the data for text processing generation means 235 generates data for text processing in which the event of the speech index “15” and, in addition, the event of “14” that “It is a printer of company A” are eliminated. FIG. 15 depicts an explanatory view illustrating an example of data for text processing generated by the data for text processing generation means 235. In addition, a bracket attached to an entry illustrated in FIG. 15 indicates an extraction source speech index. In the example illustrated in FIG. 15, an utterance of “It is a printer of company A” is deleted (the above is step C5).

Finally, the output means 220 outputs the data for text processing generated by the data for text processing generation means 235 (step C6).

As described above, in processing in step C5, the dialog text analysis device according to the present example can change factuality by way of subsequent confirmation or asking and a response by an inquiry/response pair for an event the factuality of which is determined once, and eliminate the event which is different from a final conclusion from the data for text processing.

For example, the event of the speech index “14” illustrated in FIG. 9 is determined once as an affirmative fact that “It is a printer of company A”. However, confirmation (asking) by the inquiry/response pair of the subsequent speech indices “15” and “16” changes this fact. Consequently, it is possible to generate data for text processing from which the event of the speech index that “14” that “It is a printer of company A” is eliminated.

That is, in addition to advantages of the first exemplary embodiment and the second exemplary embodiment, the dialog text analysis device according to the third exemplary embodiment can eliminate an event from the data for text processing when this event which causes confirmation or asking is different from the final conclusion. Consequently, the generated data for text processing becomes data for which text processing such as analysis like mining or search can be precisely performed as a result.

The dialog text analysis device according to the first exemplary embodiment can eliminate a fact corresponding to an event (the event of the speech index “15”) that “It is a printer of company A” which is negated by the subsequent speech of the inquiry/response pair, from the data for text processing. Further, the dialog text analysis device according to the third exemplary embodiment can further eliminate an element corresponding to the event of the speech index “14” from the data for text processing generated from the dialog text illustrated in FIG. 9. Consequently, even when the case that “It is a printer of company A” is searched, a match is not found in the dialog text illustrated in FIG. 9, so that it is possible to perform more accurate search than the dialog text analysis device according to the first exemplary embodiment.

### Example 4

Next, Example 4 of the present invention will be described. A dialog text analysis device according to Example 4 corresponds to a dialog text analysis device according to the fourth exemplary embodiment. A text which indicates communication at a call center made between a client and an operator illustrated in FIG. 18 will also be a processing object in the following description. Further, process of generating data for text processing will be described according to the flowchart illustrated in FIG. 8.

In addition, processing in steps D1 and D2 in which the input means 310 receives an input of a dialog text, and the inquiry/response pair identifying means 331 identifies an inquiry/response pair is the same as processing in steps B1 and B2 in FIG. 4. Further, processing in steps D3 and D4 in which the negative judging means 332 judges whether or not an event of a preceding utterance is negated by a subsequent utterance and the intra-utterance factuality deciding means 333 decides factuality of the preceding utterance is the same as processing in steps B3-1 and B3-2 in FIG. 4. Furthermore, processing in steps D5-1 and D5-2 in which a confirmation response of pair deciding means 334 decides whether or not the inquiry/response pair is a “confirmation (asking)-response” pair and the objective utterance for confirmation identifying means 335 identifies an utterance which is an object of the preceding utterance for confirmation or asking is the same as processing in steps C4-1 and C4-2 in FIG. 6. In addition, as long as processing in step D5-2 is performed after processing in step D5-1, an order of processing in steps D3, D4, D5-1 and D5-2 is random.

The data for text processing generation means 336 eliminates the event of the preceding utterance in the inquiry/response pair which is negated by the subsequent utterance, from the dialog text. Further, the data for text processing generation means 336 adds an event which indicates factuality opposite to factuality of the event of the preceding utterance decided in step D3, to the data for text processing instead of the eliminated event. Furthermore, the data for text processing generation means 336 changes factuality of an event of the utterance (that is, an utterance which causes confirmation or asking of the preceding utterance) identified by the objective utterance for confirmation identifying means 335 to match with factuality of the event which is added to the dialog text (that is, factuality is opposite to the original factuality).

In, for example, the example illustrated in FIG. 9, the utterance of the speech index “14” is confirmed (asked) by the utterance of the speech index “15”, and the utterance of the speech index “15” is negated by the subsequent speech (the utterance of the speech index “16”) in the inquiry/response pair. Hence, the data for text processing generation means 336 eliminates the event of the speech index “15” that “It is a printer of company A” which is an affirmative fact, from the dialog text. Further, the data for text processing generation means 336 generates data for text processing by adding to the dialog text a negative fact that “It is a printer of company A” instead of the eliminated event. Hence, the data for text processing generation means 336 changes the event of the speech index “14” that “It is a printer of company A” from the affirmative fact to a negative fact.

FIG. 16 depicts an explanatory view illustrating an example of data for text processing generated by the data for text processing generation means 336. In addition, a bracket attached to an entry illustrated in FIG. 16 indicates an extraction source speech index. In an example illustrated in FIG. 16, factuality of the speech index “14” is changed to a negative fact (the above is step D6).

Finally, the output means 320 outputs the data for text processing generated by the data for text processing generation means 336 (step D7).

As described above, in processing in step D6, the dialog text analysis device according to the present example can change factuality by way of subsequent confirmation or asking and a response by an inquiry/response pair for an event the factuality of which is determined once. Consequently, even for an event which is different from the final conclusion, it is possible to generate data for text processing of an event factuality of which is changed to match with the final conclusion.

For example, the event of the speech index “14” illustrated in FIG. 9 is determined once as an affirmative fact that “It is a printer of company A”. However, confirmation (asking) by the inquiry/response pair of the subsequent speech indices “15” and “16” changes the event of the speech index “14” that “It is a printer of company A” from an affirmative fact to a negative fact. Consequently, in addition to an advantage according to the third exemplary embodiment, it is also possible to effectively make the most of an event which causes confirmation or asking.

That is, in addition to advantages of the first exemplary embodiment and the second exemplary embodiment, the dialog text analysis device according to the fourth exemplary embodiment can change an event to match with a final conclusion when this event which causes confirmation or asking is different from the final conclusion. Consequently, the generated data for text processing becomes data for which text processing such as analysis like mining or search can be precisely performed as a result.

For example, a case that “It is a printer of company A” or a case that “It is not a printer of company A” are searched in subsequent analysis. In this case, in the data for text processing generated from the dialog text illustrated in FIG. 9, the case that “It is not a printer of company A” is included. Consequently, even when the case that “It is a printer of company A” is searched, the dialog text illustrated in FIG. 9 does not appear in a search result. Meanwhile, when the case that “It is not a printer of company A” is searched, the dialog text illustrated in FIG. 9 appears in a search result. Thus, it is possible to perform accurate search.

As described above, upon communication a call center between an operator at and a client, the operator frequently confirms or asks about an important matter in a response or an unclear matter in a speech of the client. Consequently, the dialog text analysis devices according to the third exemplary embodiment and the fourth exemplary embodiment of the present invention which focus on asking or confirmation provide an advantage particularly when an analysis object is a dialog text made at a call center.

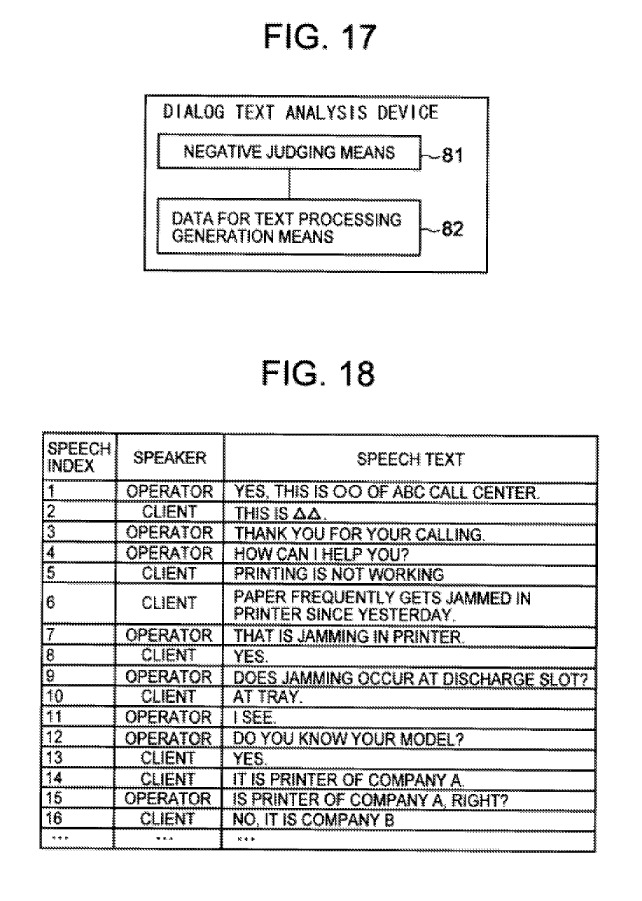

Next, an example of a minimum configuration of the present invention will be described. FIG. 17 depicts a block diagram illustrating an example of the minimum configuration of a dialog text analysis device according to the present invention. The dialog text analysis device according to the present invention comprises: negative judging means 81 (for example, the negative judging means 32) which judges whether or not an event of a first utterance (for example, a preceding utterance) in a dialog text which is a text including content of a plurality of utterances is negated by a second utterance (for example, a subsequent utterance) which exists subsequent to the first utterance; and data for text processing generation means 82 (for example, the data for text processing generation means 33) which, when the event of the first utterance is negated by the second utterance, generates data for text processing which is data in which the negated event of the first utterance is eliminated from the dialog text.

According to this configuration, it is possible to generate from the dialog text the data for text processing for which text processing such as analysis such as mining or search is precisely performed.

Further, the dialog text analysis device may have an inquiry/response pair identifying means (for example, an inquiry/response pair identifying means 31) which identifies from each utterance in an inputted dialog text an inquiry/response pair which is a pair of the first utterance which indicates content to ask to a speaker and a second utterance which exists subsequent to the first utterance and is a response to the first utterance. In this case, the negative judging means 81 may judge whether or not the event of the first utterance in the inquiry/response pair is negated by the second utterance.

Part or the entirety of the above exemplary embodiments can be described as in the following notes and, however, is by no means limited to the following notes.

(Supplementary note 1) A dialog text analysis device comprises:

negative judging means which judges whether or not an event of a first utterance in a dialog text which is a text including content of a plurality of utterances is negated by a second utterance which exists subsequent to the first utterance; and data for text processing generation means which, when the event of the first utterance is negated by the second utterance, generates data for text processing which is data in which the negated event of the first utterance is eliminated from the dialog text.

(Supplementary note 2) The dialog text analysis device described in Supplementary note 1, further comprises inquiry/response pair identifying means which identifies from each utterance in an inputted dialog text an inquiry/response pair which is a pair of the first utterance which indicates content to ask to a speaker and a second utterance which exists subsequent to the first utterance and is a response to the first utterance, and the negative judging means decides whether or not the event of the first utterance in the inquiry/response pair is negated by the second utterance.
(Supplementary note 3) In the dialog text analysis device described in Supplementary note 1 or 2, when content of the event of the first utterance negated by the second utterance indicates an affirmative fact, the data for text processing generation means changes the event which indicates the affirmative fact to an event which indicates a negative fact to add to the data for text processing, and, when the content of the event in the first utterance indicates the negative fact, changes the event which indicates the negative fact to the event which indicates the affirmative fact to add to the data for text processing.
(Supplementary note 4) In the dialog text analysis device described in any one of Supplementary notes 1 to 3, when a negative utterance which is a predetermined utterance which negates content of a preceding utterance and the second utterance match or when a feature of the negative utterance and a feature of the second utterance match, the negative judging means decides that the event of the first utterance is negated by the second utterance.
(Supplementary note 5) In the dialog text analysis device described in any one of Supplementary notes 1 to 3, when a verb used in the second utterance is an antonym of a verb used in the first utterance and other elements match or when a relationship between elements holds that part of elements used in the second utterance and part of elements used in the first utterance do not simultaneously hold, the negative judging means decides that the event of the first utterance is negated by the second utterance.
(Supplementary note 6) The dialog text analysis device described in any one of Supplementary notes 1 to 5 comprises: inquiry/response pair identifying means which identifies from each utterance in the inputted dialog text an inquiry/response pair which is a pair of the first utterance which indicates the content to ask to the speaker and the second utterance which exists subsequent to the first utterance and is a response to the first utterance; confirmation response of pair deciding means which decides whether or not a confirmation response of pair has a relationship that the first utterance in the inquiry/response pair is an event which indicates confirmation or asking, and the second utterance in the inquiry/response pair is an event which indicates a response to the confirmation or the asking; and objective utterance for confirmation identifying means which, when the inquiry/response pair is the confirmation response of pair, identifies an utterance which causes the confirmation or the asking in the first utterance, from utterances which exist prior to the first utterance among utterances in the dialog text, and the negative judging means judges whether or not the event of the first utterance in the inquiry/response pair is negated by the second utterance, and when the event of the first utterance is negated by the second utterance, the data for text processing generation means generates data for text processing from which a fact of the event in the utterance of the identified cause is eliminated.
(Supplementary note 7) In the dialog text analysis device described in Supplementary note 6, when the event of the first utterance is negated by the second utterance, or when content of the event in the utterance which causes the confirmation or the asking in the first utterance indicates an affirmative fact, the data for text processing generation means changes an event which indicates the affirmative fact to an event which indicates a negative fact to add to the data for text processing, and, when the content of the event in the utterance of the cause indicates the negative fact, changes the event which indicates the negative fact to the event which indicates the affirmative fact to add to the data for text processing.
(Supplementary note 8) In the dialog text analysis device described in Supplementary note 6 or 7, the confirmation response of pair deciding means compares similarity of words in the first utterance in the inquiry/response pair and each utterance in the dialog text which exists prior to the preceding utterance, and, when an utterance which has a higher similarity than a predetermined threshold exists prior to the first utterance, decides the inquiry/response pair as a confirmation response of pair.
(Supplementary note 9) A dialog text analysis method includes:

deciding whether or not an event of a first utterance in a dialog text which is a text including content of a plurality of utterances is negated by a second utterance which exists subsequent to the first utterance; and when the event of the first utterance is negated by the second utterance, generating data for text processing which is data in which the negated event of the first utterance is eliminated from the dialog text.

(Supplementary note 10) The dialog text analysis method described in Supplementary note 9 further includes:

identifying from each utterance in the inputted dialog text an inquiry/response pair which is a pair of the first utterance which indicates the content to ask to the speaker and the second utterance which exists subsequent to the first utterance and is a response to the first utterance; and deciding whether or not the event of the first utterance in the inquiry/response pair is negated by the second utterance.

(Supplementary note 11) A dialog text analysis program causes a computer to execute: negative judging processing of deciding whether or not an event of a first utterance in a dialog text which is a text including content of a plurality of utterances is negated by a second utterance which exists subsequent to the first utterance; and data for text processing generation processing of, when the event of the first utterance is negated by the second utterance, generating data for text processing which is data in which the negated event of the first utterance is eliminated from the dialog text.
(Supplementary note 12) The dialog text analysis program described in Supplementary note 11 further causes the computer to execute: inquiry/response pair identifying processing of identifying from each utterance in the inputted dialog text an inquiry/response pair which is a pair of the first utterance which indicates the content to ask to the speaker and the second utterance which exists subsequent to the first utterance and is a response to the first utterance, and whether or not the event of the first utterance in the inquiry/response pair is negated by the second utterance is decided in the negative judging processing.

Although the present invention has been described with reference to the exemplary embodiments and the examples, the present invention is by no means limited to the above exemplary embodiments and examples. The configurations and the details of the present invention can be variously modified within a scope of the present invention by one of ordinary skill in art.

This application claims priority to Japanese Patent Application No. 2010-259673 filed on Nov. 22, 2010, the entire contents of which are incorporated by reference herein.

### INDUSTRIAL APPLICABILITY

The present invention provides an advantage of, when text processing is performed on a dialog text in which factuality of an event is determined or changed in relation to a subsequent utterance, generating data for text processing. Consequently, the present invention is suitably applied to a dialog text analysis device which performs analysis such as texting mining or summarization or search on texts obtained by utterance-recognizing or transcribing communication such as communication (dialog) at a call center between an operator and a client, communication at a conference and communication at a store between a staff and a customer. Further, the present invention is also suitably applied to a dialog text analysis device which performs analysis such as text mining or summarization or search on a chat, Twitter (registered trademark) or a bulletin board.

### REFERENCE SIGNS LIST

10,110,210,310 input means
20,120,220,320 output means
30,130,230,330 computer
31,131,231,331 inquiry/response pair identifying means
32,132,232,332 negative judging means
33,134,235,336 data for text processing generation means
133,333 intra-utterance factuality deciding means
233,334 confirmation response of pair deciding means
234,335 Objective utterance for confirmation identifying means
41,52 subsequent utterance identifying means
42 entry comparing means
43,57 deciding means
44 negative utterance database
51 preceding utterance identifying means
53 preceding utterance role analyzing means
54 subsequent utterance role analyzing means
55 verb antonym deciding means
56 antinomy word deciding means
58 antonym database
59 antinomy word database

What is claimed is:

1. A dialog text analysis device comprising:
a negative judging unit which judges whether or not an event of a first utterance in a dialog text which is a text including content of a plurality of utterances is negated by a second utterance which exists subsequent to the first utterance; and
a data for text processing generation unit which, when the event of the first utterance is negated by the second utterance, generates data for text processing which is data in which the negated event of the first utterance is eliminated from the dialog text.

2. The dialog text analysis device according to claim 1, further comprising an inquiry/response pair identifying unit which identifies from each utterance in an inputted dialog text an inquiry/response pair which is a pair of the first utterance which indicates content to ask to a speaker and a second utterance which exists subsequent to the first utterance and is a response to the first utterance,
wherein the negative judging unit judges whether or not the event of the first utterance in the inquiry/response pair is negated by the second utterance.

3. The dialog text analysis device according to claim 1, wherein, when content of the event of the first utterance negated by the second utterance indicates an affirmative fact, the data for text processing generation unit changes the event which indicates the affirmative fact to an event which indicates a negative fact to add to the data for text processing, and, when the content of the event in the first utterance indicates the negative fact, changes the event which indicates the negative fact to the event which indicates the affirmative fact to add to the data for text processing.

4. The dialog text analysis device according to claim 1, wherein, when a negative utterance which is a predetermined utterance which negates content of a preceding utterance and the second utterance match or when a feature of the negative utterance and a feature of the second utterance match, the negative judging unit judges that the event of the first utterance is negated by the second utterance.

5. The dialog text analysis device according to claim 1, wherein, when a verb used in the second utterance is an antonym of a verb used in the first utterance and other elements match or when a relationship between elements holds that part of elements used in the second utterance and part of elements used in the first utterance do not simultaneously hold, the negative judging unit judges that the event of the first utterance is negated by the second utterance.

6. The dialog text analysis device according to claim 1, further comprising:
an inquiry/response pair identifying unit which identifies from each utterance in the inputted dialog text an inquiry/response pair which is a pair of the first utterance which indicates the content to ask to the speaker and the second utterance which exists subsequent to the first utterance and is a response to the first utterance;
a confirmation response of pair deciding unit which decides whether or not a confirmation response of pair comprises a relationship that the first utterance in the inquiry/response pair is an event which indicates confirmation or asking, and the second utterance in the inquiry/response pair is an event which indicates a response to the confirmation or the asking; and
an objective utterance for confirmation identifying unit which, when the inquiry/response pair is the confirmation response of pair, identifies an utterance which causes the confirmation or the asking in the first utterance, from utterances which exist prior to the first utterance among utterances in the dialog text, wherein:
the negative judging unit decides whether or not the event of the first utterance in the inquiry/response pair is negated by the second utterance; and
when the event of the first utterance is negated by the second utterance, the data for text processing generation unit generates data for text processing from which a fact of the event in the utterance of the identified cause is eliminated.

7. The dialog text analysis device according to claim 6, wherein, when the event of the first utterance is negated by the second utterance, or when content of the event in the utterance which causes the confirmation or the asking in the first utterance indicates an affirmative fact, the data for text processing generation unit changes an event which indicates the affirmative fact to an event which indicates a negative fact to add to the data for text processing, and, when the content of the event in the utterance of the cause indicates the negative fact, changes the event which indicates the negative fact to the event which indicates the affirmative fact to add to the data for text processing.

8. The dialog text analysis device according to claim 6, wherein the confirmation response of pair deciding unit compares similarity of words in the first utterance in the inquiry/response pair and each utterance in the dialog text which exists prior to the preceding utterance, and, when an utterance which comprises a higher similarity than a predetermined threshold exists prior to the first utterance, decides the inquiry/response pair as a confirmation response of pair.

9. A dialog text analysis method comprising:
judging whether or not an event of a first utterance in a dialog text which is a text including content of a plurality of utterances is negated by a second utterance which exists subsequent to the first utterance; and
when the event of the first utterance is negated by the second utterance, generating data for text processing which is data in which the negated event of the first utterance is eliminated from the dialog text.

10. A non-transitory computer readable information recording medium storing a dialog text analysis program, when executed by a processor, performs:
negative judging processing of deciding whether or not an event of a first utterance in a dialog text which is a text including content of a plurality of utterances is negated by a second utterance which exists subsequent to the first utterance; and
data for text processing generation processing of, when the event of the first utterance is negated by the second utterance, generating data for text processing which is data in which the negated event of the first utterance is eliminated from the dialog text.

11. The dialog text analysis device according to claim 2, wherein, when content of the event of the first utterance negated by the second utterance indicates an affirmative fact, the data for text processing generation unit changes the event which indicates the affirmative fact to an event which indicates a negative fact to add to the data for text processing, and, when the content of the event in the first utterance indicates the negative fact, changes the event which indicates the negative fact to the event which indicates the affirmative fact to add to the data for text processing.

12. The dialog text analysis device according to claim 2, wherein, when a negative utterance which is a predetermined utterance which negates content of a preceding utterance and the second utterance match or when a feature of the negative utterance and a feature of the second utterance match, the negative judging unit judges that the event of the first utterance is negated by the second utterance.

13. The dialog text analysis device according to claim 3, wherein, when a negative utterance which is a predetermined utterance which negates content of a preceding utterance and the second utterance match or when a feature of the negative utterance and a feature of the second utterance match, the negative judging unit judges that the event of the first utterance is negated by the second utterance.

14. The dialog text analysis device according to claim 2, wherein, when a verb used in the second utterance is an antonym of a verb used in the first utterance and other elements match or when a relationship between elements holds that part of elements used in the second utterance and part of elements used in the first utterance do not simultaneously hold, the negative judging unit judges that the event of the first utterance is negated by the second utterance.

15. The dialog text analysis device according to claim 3, wherein, when a verb used in the second utterance is an antonym of a verb used in the first utterance and other elements match or when a relationship between elements holds that part of elements used in the second utterance and part of elements used in the first utterance do not simultaneously hold, the negative judging unit judges that the event of the first utterance is negated by the second utterance.

16. The dialog text analysis device according to claim 2, further comprising:
an inquiry/response pair identifying unit which identifies from each utterance in the inputted dialog text an inquiry/response pair which is a pair of the first utterance which indicates the content to ask to the speaker and the second utterance which exists subsequent to the first utterance and is a response to the first utterance;
a confirmation response of pair deciding unit which decides whether or not a confirmation response of pair comprises a relationship that the first utterance in the inquiry/response pair is an event which indicates confirmation or asking, and the second utterance in the inquiry/response pair is an event which indicates a response to the confirmation or the asking; and
an objective utterance for confirmation identifying unit which, when the inquiry/response pair is the confirmation response of pair, identifies an utterance which causes the confirmation or the asking in the first utterance, from utterances which exist prior to the first utterance among utterances in the dialog text, wherein:
the negative judging unit decides whether or not the event of the first utterance in the inquiry/response pair is negated by the second utterance; and
when the event of the first utterance is negated by the second utterance, the data for text processing generation unit generates data for text processing from which a fact of the event in the utterance of the identified cause is eliminated.

17. The dialog text analysis device according to claim 3, further comprising:
an inquiry/response pair identifying unit which identifies from each utterance in the inputted dialog text an inquiry/response pair which is a pair of the first utterance which indicates the content to ask to the speaker and the second utterance which exists subsequent to the first utterance and is a response to the first utterance;
a confirmation response of pair deciding unit which decides whether or not a confirmation response of pair comprises a relationship that the first utterance in the inquiry/response pair is an event which indicates confirmation or asking, and the second utterance in the inquiry/response pair is an event which indicates a response to the confirmation or the asking; and
an objective utterance for confirmation identifying unit which, when the inquiry/response pair is the confirmation response of pair, identifies an utterance which causes the confirmation or the asking in the first utterance, from utterances which exist prior to the first utterance among utterances in the dialog text, wherein:
the negative judging unit decides whether or not the event of the first utterance in the inquiry/response pair is negated by the second utterance; and
when the event of the first utterance is negated by the second utterance, the data for text processing generation unit generates data for text processing from which a fact of the event in the utterance of the identified cause is eliminated.

18. The dialog text analysis device according to claim 4, further comprising:
an inquiry/response pair identifying unit which identifies from each utterance in the inputted dialog text an inquiry/response pair which is a pair of the first utterance which indicates the content to ask to the speaker and the second utterance which exists subsequent to the first utterance and is a response to the first utterance;
a confirmation response of pair deciding unit which decides whether or not a confirmation response of pair comprises a relationship that the first utterance in the inquiry/response pair is an event which indicates confirmation or asking, and the second utterance in the inquiry/response pair is an event which indicates a response to the confirmation or the asking; and
an objective utterance for confirmation identifying unit which, when the inquiry/response pair is the confirmation response of pair, identifies an utterance which causes the confirmation or the asking in the first utterance, from utterances which exist prior to the first utterance among utterances in the dialog text, wherein:
the negative judging unit decides whether or not the event of the first utterance in the inquiry/response pair is negated by the second utterance; and
when the event of the first utterance is negated by the second utterance, the data for text processing generation unit generates data for text processing from which a fact of the event in the utterance of the identified cause is eliminated.

19. The dialog text analysis device according to claim 5, further comprising:
an inquiry/response pair identifying unit which identifies from each utterance in the inputted dialog text an inquiry/response pair which is a pair of the first utterance which indicates the content to ask to the speaker and the second utterance which exists subsequent to the first utterance and is a response to the first utterance;
a confirmation response of pair deciding unit which decides whether or not a confirmation response of pair comprises a relationship that the first utterance in the inquiry/response pair is an event which indicates confirmation or asking, and the second utterance in the inquiry/response pair is an event which indicates a response to the confirmation or the asking; and
an objective utterance for confirmation identifying unit which, when the inquiry/response pair is the confirmation response of pair, identifies an utterance which causes the confirmation or the asking in the first utterance, from utterances which exist prior to the first utterance among utterances in the dialog text, wherein:
the negative judging unit decides whether or not the event of the first utterance in the inquiry/response pair is negated by the second utterance; and
when the event of the first utterance is negated by the second utterance, the data for text processing generation unit generates data for text processing from which a fact of the event in the utterance of the identified cause is eliminated.
